(19) United States
(12) Patent Application Publication
(10) Pub. No.: US 2017/0269678 A1
(43) Pub. Date: Sep. 21, 2017

(54) INFORMATION PROCESSING DEVICE, POWER MEASURING METHOD, AND NON-TRANSITORY RECORDING MEDIUM STORING POWER MEASURING PROGRAM

(71) Applicant: FUJITSU LIMITED, Kawasaki-shi (JP)

(72) Inventors: Miyuki Matsuo, Yokohama (JP); Kohta Nakashima, Kawasaki (JP)

(73) Assignee: FUJITSU LIMITED, Kawasaki-shi (JP)

(21) Appl. No.: 15/383,349

(22) Filed: Dec. 19, 2016

(30) Foreign Application Priority Data
Mar. 17, 2016 (JP) 2016-054078

(51) Int. Cl. G06F 1/32

(52) U.S. Cl. CPC G06F 1/3287; G06F 1/3228

(57) ABSTRACT

An information processing device includes: a memory configured to store a power measuring program; and a processor configured to execute the power measuring program, wherein the processor, based on the power measuring program, identifying an event to be used for sampling of an amount of power consumption by using a power consumption model based on the event occurring in the processor; and calculating a sampling interval of an identified event based on an electric energy sampling interval as a sampling interval of the amount of power consumption and the power consumption model.

### CROSS-REFERENCE TO RELATED APPLICATION

This application is based upon and claims the benefit of priority of the prior Japanese Patent Application No. 2016-054078, filed on Mar. 17, 2016, the entire contents of which are incorporated herein by reference.

### FIELD

The embodiment discussed herein is related to an information processing device, a power measuring method, and a non-transitory recording medium storing power measuring program.

### BACKGROUND

Power consumption of information and communication technology (ICT) systems is increasing. The power consumption of a supercomputer, for example, exceeds 10 MW.

Related art is disclosed in Japanese Laid-open Patent Publication No. 2007-249961 or Japanese Laid-open Patent Publication No. 2015-175630.

### SUMMARY

According to an aspect of the embodiments, an information processing device includes: a memory configured to store a power measuring program; and a processor configured to execute the power measuring program, wherein the processor, based on the power measuring program, identifying an event to be used for sampling of an amount of power consumption by using a power consumption model based on the event occurring in the processor; and calculating a sampling interval of an identified event based on an electric energy sampling interval as a sampling interval of the amount of power consumption and the power consumption model.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of measurement of amounts of power consumption;

FIG. 2 illustrates an example of sampling of amounts of power consumption in an information processing device;

FIG. 3 illustrates an example of an information processing device;

FIG. 4 illustrates an example of a processor;

FIG. 5 illustrates an example of processing of a power measuring unit; and

FIG. 6 illustrates an example of processing of determining events and sampling intervals.

### DESCRIPTION OF EMBODIMENT

A supercomputer having a good power efficiency, for example, has realized 7.032 GFlops (gigaflops)/W (watt). However, power consumption at 1 EFlop (exaflop) is 10¹⁸/(7.032×10⁹)=142 MW. A supercomputer with such a high power consumption may not be able to be realized.

In order to optimize a program from a viewpoint of power saving, for example, a hot spot of power consumption of the program may be identified. The power consumption of the program may be reduced by tuning the identified hot spot. For example, an amount of power consumption may be sampled at uniform time intervals, and the hot spot may be identified using information about an operating program which information is sampled at similar time intervals.

For example, in order to improve power characteristics, in a system including a processor, a power measuring device measuring power used by the processor during the execution of a program, and a memory storing a power profile related to the program, the power profile may be determined by the power measuring device.

For example, correspondence relation of time to a software operation log and a power consumption log may be determined, and the software operation log and the power consumption log may be output in association with common time information based on the determined correspondence relation of time. Consumed power may be thereby analyzed.

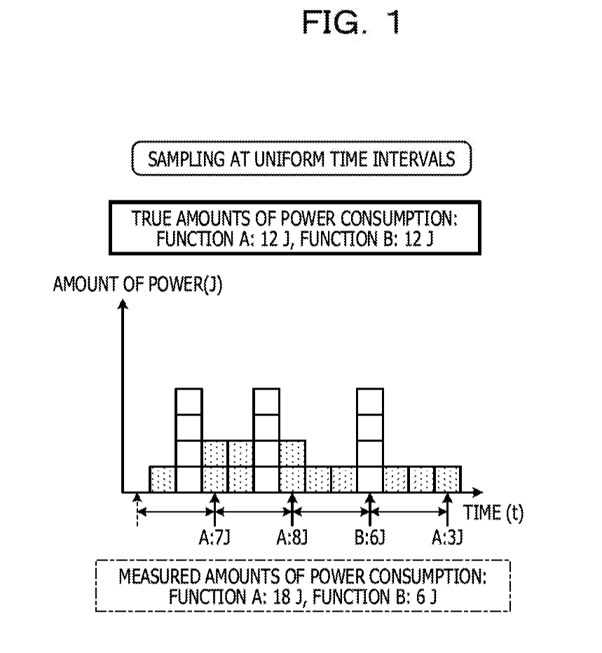

A technology that samples an amount of power consumption at uniform time intervals, for example, may not measure the amount of power consumption accurately. FIG. 1 illustrates an example of measurement of amounts of power consumption. In FIG. 1, amounts of power consumption is obtained by interrupts at uniform time intervals, and amounts of power consumption of respective functions is calculated based on information about the functions executed at the times of the interrupts. An axis of abscissas in FIG. 1 represents time. An axis of ordinates in FIG. 1 represents an amount of power. The unit of the amount of power is J (joule).

In FIG. 1, amounts of power consumption by a function A are represented with a pattern, and amounts of power consumption by a function B are represented without a pattern. As illustrated in FIG. 1, the amount of power consumption by the function A and the amount of power consumption by the function B are both 12 J. For example, when amounts of power consumption are sampled by interrupts at uniform time intervals, and an amount of power consumption of 7 J is obtained by a first sampling, the function A is executed at the time of the first sampling, and therefore the amount of power consumption of the function A becomes 7 J.

When an amount of power consumption of 8 J is obtained by a second sampling, the function A is executed at the time of the second sampling, and therefore the amount of power consumption of the function A may become 7 J+8 J=15 J. When an amount of power consumption of 6 J is obtained by a third sampling, the function B may be executed at the time of the third sampling, and therefore the amount of power consumption of the function B may become 6 J. When an amount of power consumption of 3 J is obtained by a fourth sampling, the function A is executed at the time of the fourth sampling, and therefore the amount of power consumption of the function A becomes 15 J+3 J=18 J.

Despite of the fact that the amount of power consumption by the function A and the amount of power consumption by the function B are both 12 J, the amounts of power consumption obtained by the four times of sampling are 18 J for the function A and 6 J for the function B. Thus, accurate amounts of power consumption may not be obtained.

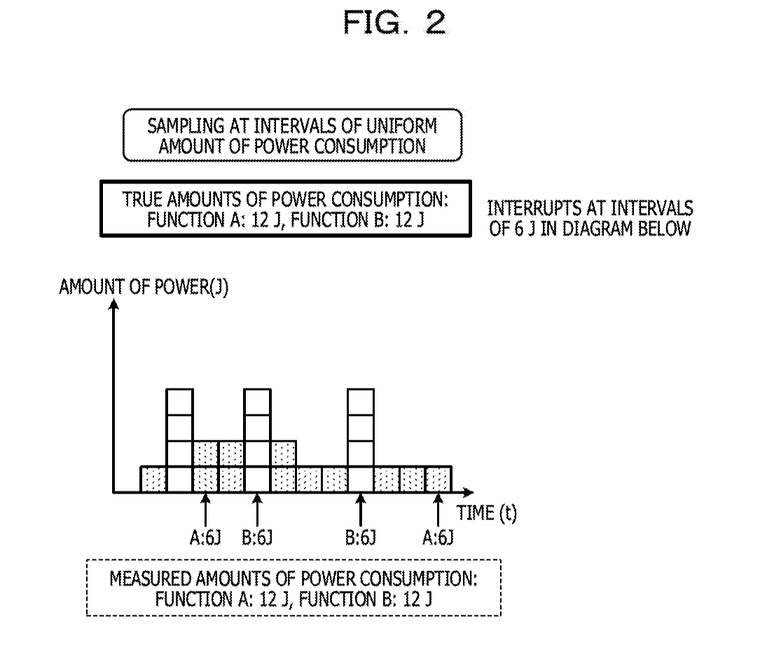

FIG. 2 illustrates an example of sampling of amounts of power consumption in an information processing device. In FIG. 2, as in FIG. 1, the amount of power consumption by the function A and the amount of power consumption by the function B are both 12 J.

As illustrated in FIG. 2, when sampling is performed at intervals of a uniform amount of power consumption of 6 J, the function A is executed at the time of a first sampling, and therefore the amount of power consumption of the function A becomes 6 J.

The function B is executed at the time of a second sampling, and therefore the amount of power consumption of the function B becomes 6 J. The function B is executed at the time of a third sampling, and therefore the amount of power consumption of the function B becomes 6 J+6 J=12 J. The function A is executed at the time of a fourth sampling, and therefore the amount of power consumption of the function A becomes 6 J+6 J=12 J.

The information processing device thus performs sampling at intervals of a uniform amount of power consumption, for example, power consumption amount-based sampling. Therefore, the amounts of power consumption of the respective functions may be measured more accurately as compared with the case where sampling at uniform time intervals, for example, time-based sampling is performed. It may be difficult to perform sampling by generating interrupts at intervals of a uniform amount of power consumption, for example. The information processing device may therefore perform sampling at intervals of as uniform an amount of power consumption as possible.

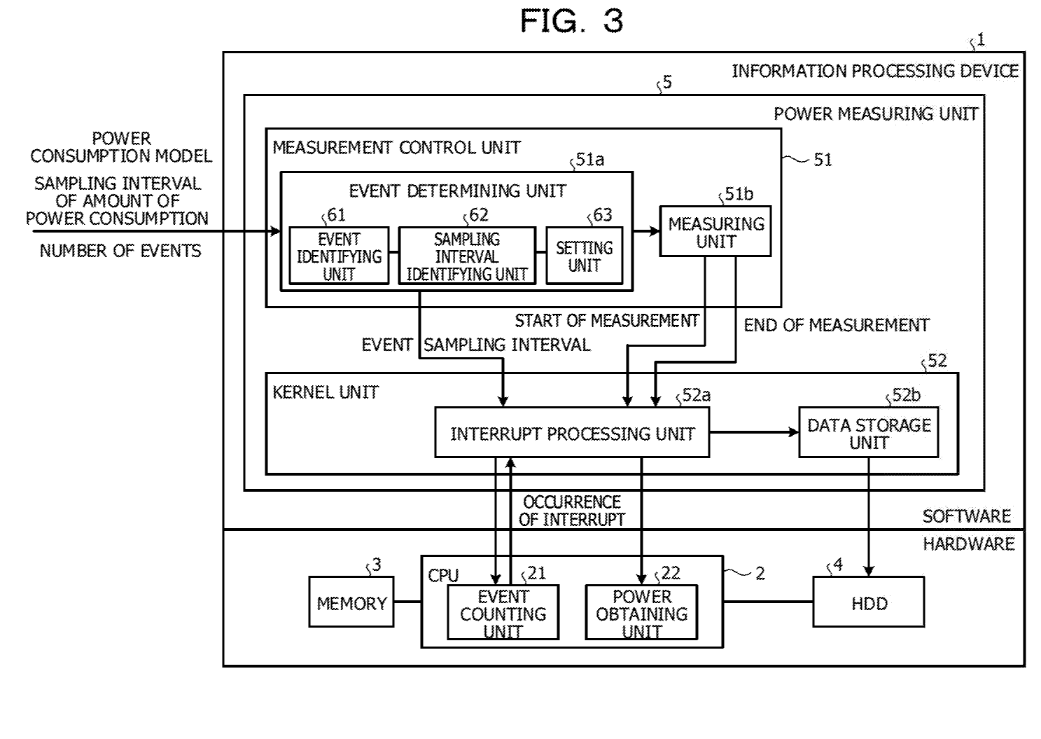

FIG. 3 illustrates an example of an information processing device. As illustrated in FIG. 3, an information processing device 1 includes a central processing unit (CPU) 2, a memory 3, and a hard disk drive (HDD) 4 as hardware, and includes a power measuring unit 5 implemented by software.

The CPU 2 is a central processing unit that reads a program from the memory 3 and executes the program. The memory 3 is a random access memory (RAM) that stores the program, an intermediate result of the execution of the program, and the like. The HDD 4 is a disk device that stores the program or data.

The CPU 2 includes an event counting unit 21 and a power obtaining unit 22. The event counting unit 21 includes an event setting register in which a type of event occurring in the CPU 2 is set and a counter register for counting the number of times of occurrence of the event. The event may, for example, include a cache miss in an L (Level) 3 cache, a prefetch for access to an L2 cache, or the like. The event counting unit 21 includes a plurality of sets of the event setting registers and the counter registers.

Whether or not to generate an interrupt may be specified in the event setting register. When the event for which the generation of an interrupt is specified occurs a number of times set in the counter register, the event counting unit 21 generates the interrupt to the CPU 2. The event counting unit 21 in an x-86 architecture, for example, may be a performance monitoring counter (PMC).

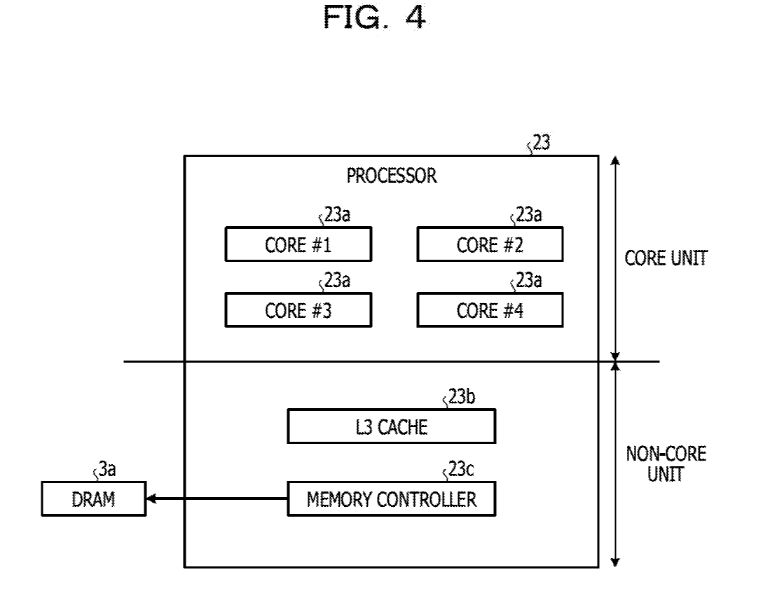

The power obtaining unit 22 obtains information about amounts of power consumption of a processor, the whole of cores included in the processor, and a dynamic random access memory (DRAM) or the like. FIG. 4 illustrates an example of a processor. A processor 23 includes four cores 23a as a core unit, and includes an L3 cache 23b and a memory controller 23c as a non-core unit.

The cores 23a are arithmetic processing devices that perform operation. The L3 cache 23b is a cache memory that stores part of data stored in a DRAM 3a. The memory controller 23c controls access to the DRAM 3a. The DRAM 3a corresponds to the memory 3 illustrated in FIG. 3. The processor 23 may be included in the CPU 2 illustrated in FIG. 3.

The power obtaining unit 22 may obtain the amount of power consumption of the whole of the cores, but may not obtain the amount of power consumption of each individual core. The power obtaining unit 22 may not generate an interrupt at intervals of an amount of power consumption. The power obtaining unit 22 may, for example, be a running average power limit (RAPL) from Intel (registered trademark).

In FIG. 3, the power measuring unit 5 samples data at intervals of as uniform an amount of power consumption as possible, using the event counting unit 21 and the power obtaining unit 22. The information processing device 1 may not have a function of generating an interrupt at intervals of a uniform amount of power consumption. The power measuring unit 5 therefore samples data at intervals of as uniform an amount of power consumption as possible by identifying an event related to power consumption and generating an interrupt using the identified event. The power measuring unit 5 includes a measurement control unit 51 and a kernel unit 52.

The measurement control unit 51 controls the sampling of data based on the event and the sampling interval of the event. The measurement control unit 51 includes an event determining unit 51a and a measuring unit 51b. The event determining unit 51a is supplied with a power consumption model, the sampling interval of an amount of power consumption, and the number of events that cause an interrupt to occur. The event determining unit 51a performs processing related to the events used for the sampling of power consumption.

The power consumption model is a model for calculating the power consumption of the processor 23 based on the events occurring in the CPU 2. There is, for example, a power consumption model as follows:

Power Consumption [W]=13.06+
7.136×C+
1.157×10⁻⁸×L2_TRANS. ALL_PF+
3.841×10⁻⁸×LONGESTLATCACHE. MISS

C denotes a rate at which the CPU 2 operates actively, and is calculated from core performance information. L2_TRANS. ALL_PF denotes the number of prefetches for access to the L2 cache. A prefetch for access to the L2 cache represents an event that may be set in the event setting register. LONGEST_LAT_CACHE. MISS denotes the number of cache misses in the L3 cache 23b. A cache miss in the L3 cache 23b represents an event that may be set in the event setting register.

The sampling interval of an amount of power consumption represents an amount of power consumption up to a next sampling. The number of events that cause an interrupt to occur may be the number of events used for interrupt generation among the events included in the power consumption model.

The event determining unit 51a includes an event identifying unit 61, a sampling interval identifying unit 62, and a setting unit 63. The event identifying unit 61 is supplied with the power consumption model and the number of events that cause an interrupt to occur, and identifies the events that cause an interrupt to occur. In a case where the number of events that cause an interrupt to occur is one, for example, the event identifying unit 61 may identify an event having a highest coefficient in the power consumption model as an event that causes an interrupt to occur.

Suppose that the power consumption model is defined as follows:

Power Consumption=0.003×Number of L3 Cache Misses+0.001×Number of L2 Cache Accesses (1)

In the case where the number of events that cause an interrupt to occur is one, the L3 cache miss is identified as an event that causes an interrupt to occur.

In a case where the number of events that cause an interrupt to occur is more than one, for example, the event identifying unit 61 selects a specified number of events in order of decreasing coefficients of the events in the power consumption model, and identifies the selected events as events that cause an interrupt to occur. In a case where the power consumption model is the above-described Equation (1), and the number of events that cause an interrupt to occur is two, the L3 cache miss and the L2 cache access may be identified as events that cause an interrupt to occur. An event having a considerably small coefficient value as compared with the other coefficients, for example, may not be selected even when that event is within the specified number.

The event identifying unit 61 may, for example, display a plurality of power consumption models on a display device. A user may select a power consumption model by a mouse, and input the power consumption model to the event identifying unit 61. To the event identifying unit 61, for example, the number of events that cause an interrupt to occur may be input from a keyboard by the user.

The sampling interval identifying unit 62 identifies the sampling intervals of the events identified by the event identifying unit 61 based on the sampling interval of the amount of power consumption and the coefficients of the events in the power consumption model. The sampling interval identifying unit 62, for example, calculates the sampling intervals of the respective events by multiplying a sampling interval of the amount of power consumption by the reciprocals of the coefficients of the respective events. For example, Sampling Interval of Event=Sampling Interval of Amount of Power Consumption/Event Coefficient.

For example, when the sampling interval of the amount of power consumption is 6 J, and the power consumption model is the above-described Equation (1), L3 Cache Miss Sampling Interval=6/0.003=2000 Times. L2 Cache Access Sampling Interval=6/0.001=6000 Times.

When the number of events that cause an interrupt to occur is one, it means that the sampling interval identifying unit 62 does not take amounts of consumption by the other events into consideration. Therefore, the sampling interval may be reduced by adding a certain value a to the coefficient of the event. For example, in a case where only the L3 cache miss is set as an event, and a=0.001, Sampling Interval=6/(0.003+0.001)=1500 Times.

To the sampling interval identifying unit 62 the sampling interval of the amount of power consumption may be input from the keyboard by the user. To the sampling interval identifying unit 62, a total amount of power consumption of a measurement object program and the number of samples desired to be extracted are input from the keyboard by the user. The sampling interval of the amount of power consumption is calculated as Total Amount of Power Consumption/Number of Samples. For example, when the total amount of power consumption is 12000 J, and the number of samples is 2000, Sampling Interval of Amount of Power Consumption=12000 J/2000=6 J.

The setting unit 63 instructs the kernel unit 52 to set the events and the sampling intervals identified by the event determining unit 51a in the event counting unit 21.

The measuring unit 51b instructs the kernel unit 52 to start measuring power consumption using the events and the sampling intervals set by the setting unit 63. The measuring unit 51b instructs the kernel unit 52 to end the measurement by specifying a measurement time.

The kernel unit 52 may be implemented by a kernel function of an operating system (OS). The kernel unit 52 includes an interrupt processing unit 52a and a data storage unit 52b.

The interrupt processing unit 52a is started by an interrupt from the event counting unit 21. The interrupt processing unit 52a extracts performance data. The performance data includes a process identification (ID) identifying a process, program information such as an instruction address or the like, an amount of power consumption obtained by the power obtaining unit 22, an event value indicating a kind of event that causes the interrupt to occur. The interrupt processing unit 52a stores the extracted performance data as sample data in the data storage unit 52b.

The data storage unit 52b stores the performance data extracted by the interrupt processing unit 52a. The performance data stored by the data storage unit 52b is written to the HDD 4 after an end of the measurement. The performance data written to the HDD 4 is analyzed separately for identification of a hot spot of power consumption or the like.

The power measuring unit 5 is implemented by reading out a power measuring program stored on the HDD 4 from the HDD 4 into the memory 3 and executing the power measuring program by the CPU 2. The power measuring program is, for example, read out from a digital versatile disk (DVD) and installed on the information processing device 1. The power measuring program is, for example, stored in a database of another information processing device or the like coupled via a local area network (LAN), read out from the database, and installed on the information processing device 1.

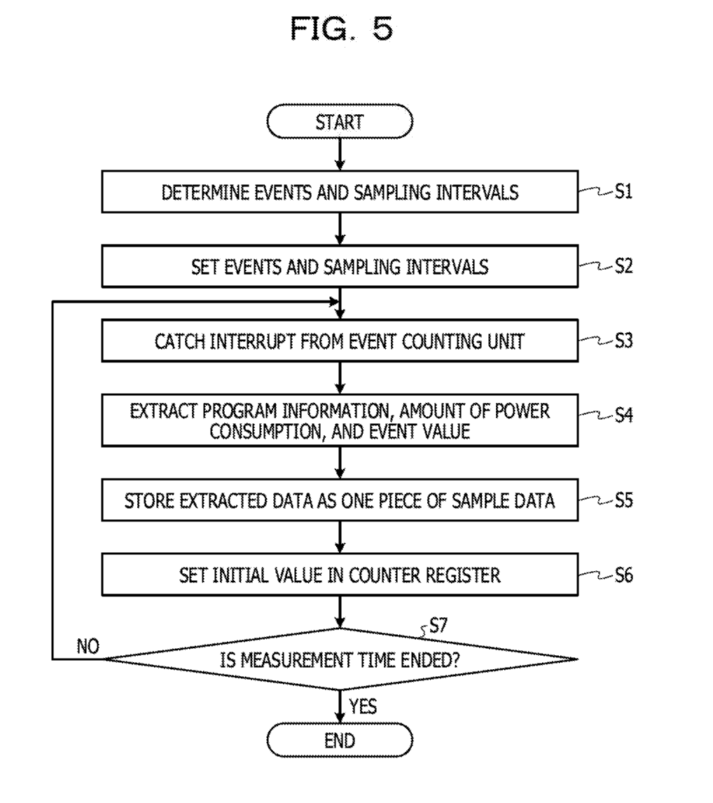

FIG. 5 illustrates an example of processing of a power measuring unit. As illustrated in FIG. 5, the power measuring unit 5 determines events that cause an interrupt to occur and sampling intervals (operation S1), and sets the determined events and the determined sampling intervals in the event counting unit 21 (operation S2). Operation 51 and operation S2 may be performed by the measurement control unit 51.

When the measurement object program is executed and measurement is started, the interrupt processing unit 52a catches an interrupt from the event counting unit 21 (operation S3), and extracts program information, an amount of power consumption, and an event value (operation S4). The interrupt processing unit 52a stores the extracted data as one piece of sample data in the data storage unit 52b (operation S5), and sets an initial value, for example, the sampling interval, in the counter register corresponding to the event that causes the interrupt to occur (operation S6).

The interrupt processing unit 52a determines whether or not the measurement time is ended (operation S7). When the measurement time is not ended, the processing returns to operation S3. When the measurement time is ended, the measurement processing is ended.

Thus, the measurement control unit 51 determines the events that cause an interrupt to occur and the sampling intervals, and the interrupt processing unit 52a extracts the performance data using the events and the sampling intervals determined by the measurement control unit 51. The power measuring unit 5 performs sampling approximate to power consumption amount-based sampling by performing event-based sampling using the events related to power consumption.

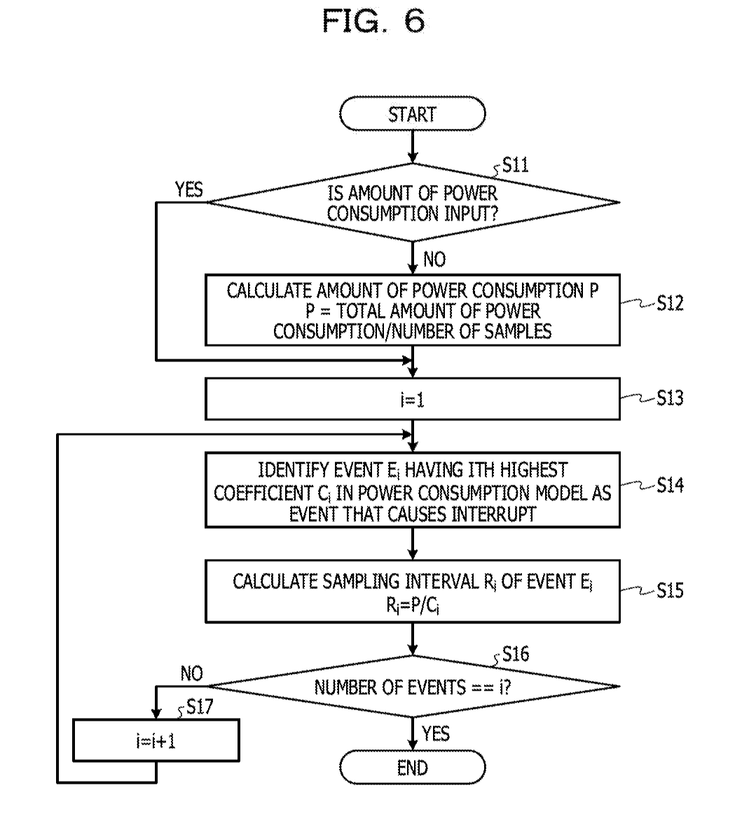

FIG. 6 illustrates an example of processing of determining events and sampling intervals. The processing of determining the events and the sampling intervals illustrated in FIG. 6, may correspond to operation S1 illustrated in FIG. 5.

As illustrated in FIG. 6, the event determining unit 51a determines whether or not an amount of power consumption as a sampling interval is input (operation S11). When the amount of power consumption is input, the processing proceeds to operation S13.

When the amount of power consumption is not input, the event determining unit 51a receives the input of a total amount of power consumption and a number of samples, and calculates an amount of power consumption P as a sampling interval by P=Total Amount of Power Consumption/Number of Samples (operation S12).

The event determining unit 51a initializes i to one (operation S13). The event determining unit 51a identifies an event Eᵢ having an ith highest coefficient Cᵢ in the power consumption model as an event that causes an interrupt (operation S14). The event determining unit 51a calculates a sampling interval Rᵢ of the event Eᵢ by Rᵢ=P/Cᵢ (operation S15).

The event determining unit 51a determines whether or not the number of events that cause an interrupt to occur and i are equal to each other (operation S16). When the number of events that cause an interrupt to occur and i are not equal to each other, the event determining unit 51a adds one to i (operation S17). The processing then returns to operation S14. When the number of events that cause an interrupt to occur and i are equal to each other, the processing is ended. “==” denotes equality.

The event identifying unit 61 is supplied with the power consumption model and the number of events that cause an interrupt to occur, and identifies the events that cause an interrupt to occur. The sampling interval identifying unit 62 identifies the sampling intervals of the events identified by the event identifying unit 61 based on the sampling interval of the amount of power consumption and the power consumption model. The power measuring unit 5 therefore samples performance data by event-based sampling using the events related to power consumption. Amounts of power consumption may be measured more accurately as compared with time-based sampling.

The setting unit 63 instructs the kernel unit 52 to set the identified events and the identified sampling intervals in the event counting unit 21. When the measurement object program is executed, the event counting unit 21 counts the events, and generates an interrupt. The interrupt processing unit 52a extracts performance data, and stores the performance data in the data storage unit 52b. The power measuring unit 5 therefore samples the performance data using the events identified by the event identifying unit 61 and the sampling intervals identified by the sampling interval identifying unit 62.

When the number of events that cause an interrupt to occur is more than one, the event identifying unit 61 selects a specified number of events in order of decreasing coefficients of the events in the power consumption model, and identifies the selected events as events that cause an interrupt to occur. Hence, interrupts may be generated based on the events that have a large effect on power consumption, and performance data may be sampled by event-based sampling approximate to power consumption amount-based sampling.

When the number of events that cause an interrupt to occur is one, the sampling interval identifying unit 62 reduces the sampling interval by adding a certain value a to the coefficient of the event. Hence, the power measuring unit 5 samples performance data in consideration of amounts of consumption by the other events.

The sampling interval identifying unit 62 calculates the sampling interval of the amount of power consumption based on the total amount of power consumption of the measurement object program and the number of samples desired to be extracted. Hence, the user may specify the total amount of power consumption of the measurement object program and the number of samples desired to be extracted in place of the sampling interval of the amount of power consumption.

The measurement control unit 51 may be in the same information processing device as the kernel unit 52, or the measurement control unit 51 may be in another information processing device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing device comprising:
a memory configured to store a power measuring program; and
a processor configured to execute the power measuring program,
wherein the processor, based on the power measuring program,
identifying an event to be used for sampling of an amount of power consumption by using a power consumption model based on the event occurring in the processor; and
calculating a sampling interval of an identified event based on an electric energy sampling interval as a sampling interval of the amount of power consumption and the power consumption model.

2. The information processing device according to claim 1, wherein
when an interrupt is generated based on the identified event and the sampling interval of the identified event, the processor extracts program information and the amount of power consumption, and stores the program information and the amount of power consumption as sample data.

3. The information processing device according to claim 1, wherein
the processor identifies a given number of events in order of decreasing coefficients of the events in the power consumption model as the identified event.

4. The information processing device according to claim 1, wherein
when the processor identifies one event having a highest coefficient among a plurality of events included in the power consumption model as the identified event, the processor calculates the sampling interval of the identified event based on a value obtained by increasing the coefficient of the identified event.

5. The information processing device according to claim 1, wherein
the processor calculates the electric energy sampling interval based on a total amount of power consumption of a program and a number of samples to be extracted.

6. A power measuring method comprising:
identifying, by a computer, an event to be used for sampling of an amount of power consumption by using a power consumption model based on the event occurring in the processor; and
calculating a sampling interval of an identified event based on an electric energy sampling interval as a sampling interval of the amount of power consumption and the power consumption model.

7. The power measuring method according to claim 6, further comprising:
extracting, when an interrupt is generated based on the identified event and the sampling interval of the identified event, program information and the amount of power consumption; and
storing the program information and the amount of power consumption as sample data.

8. The power measuring method according to claim 6, wherein
a given number of events are identified in order of decreasing coefficients of the events in the power consumption model as the identified event.

9. The power measuring method according to claim 6, wherein,
when one event having a highest coefficient among a plurality of events included in the power consumption model is identified as the identified event, the sampling interval of the identified event is calculated based on a value obtained by increasing the coefficient of the identified event.

10. The power measuring method according to claim 6, further comprising:
calculating the electric energy sampling interval based on a total amount of power consumption of a program and a number of samples to be extracted.

11. A non-transitory recording medium storing power measuring program comprising:
identifying an event to be used for sampling of an amount of power consumption by using a power consumption model based on the event occurring in the processor; and
calculating a sampling interval of an identified event based on an electric energy sampling interval as a sampling interval of the amount of power consumption and the power consumption model.

12. The non-transitory recording medium according to claim 11, further comprising:
extracting, when an interrupt is generated based on the identified event and the sampling interval of the identified event, program information and the amount of power consumption; and
storing the program information and the amount of power consumption as sample data.

13. The non-transitory recording medium according to claim 11, wherein
a given number of events are identified in order of decreasing coefficients of the events in the power consumption model as the identified event.

14. The non-transitory recording medium according to claim 11, wherein,
when one event having a highest coefficient among a plurality of events included in the power consumption model is identified as the identified event, the sampling interval of the identified event is calculated based on a value obtained by increasing the coefficient of the identified event.

15. The non-transitory recording medium according to claim 11, further comprising:
calculating the electric energy sampling interval based on a total amount of power consumption of a program and a number of samples to be extracted.
